(19) United States
(12) Patent Application Publication
(10) Pub. No.: US 2026/0204783 A1
(43) Pub. Date: Jul. 16, 2026

(54) ULTRA-WIDEBAND FRASERA ANTENNA RADIATOR (UFAR) FOR FIFTH AND SIXTH GENERATION (5G/6G) ARRAY ANTENNAS

(71) Applicant: Telefonaktiebolaget LM Ericsson (publ), Stockholm (SE)

(72) Inventors: Marthinus DA SILVEIRA, Ottawa (CA); Neil MCGOWAN, Stittsville (CA)

(21) Appl. No.: 19/135,921

(22) PCT Filed: Dec. 8, 2022
(86) PCT No.: PCT/IB2022/061940

§ 371 Date: Jun. 5, 2025

(51) Int. Cl. H01Q 5/25; H01Q 9/44; H01Q 25/00

(52) U.S. Cl. CPC H01Q 5/25; H01Q 9/44; H01Q 25/001

(57) ABSTRACT

Ultra-wide band (UWB) Frasera antenna elements are disclosed, including a radiator and fencing structure having features that designed to obtain 3GPP Standards-compliant levels of performance over a 45% bandwidth for return loss, polarization discrimination, polarization isolation, and mutual coupling.

### TECHNICAL FIELD

The present disclosure relates to wireless communications, and in particular, to an ultra-wide band (UWB) Frasera antenna radiator (UFAR) for Fifth Generation (5G) and Sixth Generation (6G) array antennas.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth generation (6G) wireless communication systems are also being developed.

The requirements on antennas for 5G/6G beamforming are very stringent. The key to good array performance is good antenna radiators. The radiators should not only have good electrical performance but should also have very low weight as there are many radiators needed in large 5G/6G array antennas.

Radiator spacing close to or lower than half a wavelength is needed for 5G/6G antenna array beamforming applications to avoid significant performance degradation resulting from grating lobes. Also needed for 5G/6G antenna array beamforming applications are small pattern deviations between radiators as well as good polarization, isolation and coupling properties.

In addition larger bandwidths are needed for 5G/6G antenna arrays as the number of bands and the frequency range of new bands continues to grow.

Radiators that have been designed for technologies prior to 5G/6G have a number of radiators in a column with spacing between radiators much greater than half a wavelength (0.7 to 0.85 wavelengths are typical) and typically having either one column or two columns with spacing between the columns that is much greater than half a wavelength. This is done in pre-5G/6G antennas to maximize antenna gain with a minimum number of radiators.

Early 5G antenna arrays are typically configured to have a 0.5 wavelength column spacing at the center frequency. Bandwidth for early 5G antenna arrays is typically limited to below 25% which is not enough to cover the required ultra-wide bandwidth of future 5G/6G systems. The array bandwidth is mainly limited by the radiator. An example of a 25% bandwidth prior art radiator is the Frasera Antenna Radiator (FAR) for 5G Array Antennas and Overmolded AAS Antenna Radiator

### SUMMARY

Some embodiments advantageously provide methods, systems, and apparatuses for an ultra-wide band (UWB) Frasera antenna radiator (UFAR) for Fifth Generation (5G) and Sixth Generation (6G) array antennas.

The Ultrawideband Frasera Antenna Radiators (UFARs) disclosed herein have optimal performance over a ultra-wideband with a spacing of 0.53 wavelength at the maximum frequency of the band. This is done by having a radiator geometry with minimal interaction with other elements by having optimal fencing wall features. The design meets all the requirements for network performance such as low return loss, high port to port array isolation, good radiation patterns with low cross polarization and inverse polarization parallelity as well as good azimuth pattern symmetry.

The UFARs disclosed herein has a bandwidth of 45% compared to 25% for previous versions for an increase of 1.8 times. The UFARs disclosed herein also has a very low loss due to an all metal design, simple impedance matching, and by having a simple low loss feed structure. The UFAR simple symmetric radiator design also has low weight and low cost.

The UFAR is small, symmetrical, light weight, high efficiency radiator for optimal performance in 5G/6G two-dimensional antenna arrays with spacing on the order of half a wavelength and targeted for mobile communication frequencies in use today as well as frequencies to be used in the future.

Column spacing is chosen to minimize grating lobes for steering to +-50 deg in the azimuth plane at the maximum operating frequency. The bandwidth is 1.7 to 2.7 GHz (more than 45%).

The UWB Frasera radiator disclosed herein gives a radiator and fence geometry optimized for very good port characteristics (coupling, polarization isolation) while maintaining good radiation patterns (azimuth pattern symmetry, cross polarization ratio, inverse polarization isolation) over the whole 45% bandwidth.

The fence geometry is designed to give low coupling between columns of the array while maintaining antenna element performance and array performance.

According to one aspect, an ultra-wide band (UWB) Frasera antenna element is provided. The UWB antenna element includes a radiator configured to provide a first polarization and a second polarization. The UWB antenna element includes a fencing structure forming a perimeter around the radiator, the fencing structure including two first parallel fences having a first fence height and two second parallel fences orthogonal to the two first parallel fences and having a second fence height, the two first parallel fences and the two second parallel fences forming a gap at each of four corners of the fencing structure, each of the two first parallel fences having two first outer slants, each first outer slant being configured to slope toward a corner from the first fence height to a corner height and each of the two second parallel fences having two second outer slants, each second outer slant being configured to slope toward the corner of the four corners from the second fence height to the corner height, the corner height being less than the first fence height and less than the second fence height, each of the two first parallel fences having a third fence height at a first center of the two first parallel fences, the third fence height being less than the first fence height, the two second parallel fences having a fourth fence height at a second center of the two second parallel fences, the fourth fence height being less than the second fence height.

According to this aspect, in some embodiments, a first fence of the two first parallel fences have two first inner slants sloping toward the first center of the first fence from the first fence height to the third fence height and a second fence of the two second parallel fences have two second inner slants sloping toward the second center from the second fence height to a fourth fence height of the second fence. In some embodiments, wherein each of the two first inner slants slope toward the first center of the first fence from opposite directions to the third fence height at first points separated by a first width. In some embodiments, each of the two second inner slants slope toward the second center of the second fence from opposite directions to the fourth fence height at second points separated by a second width. In some embodiments, the first width is greater than the second width. In some embodiments, the first and second fence heights are dimensioned to obtain a level of mutual coupling that is less than a first threshold over a specified bandwidth, and the first and second inner slants are sloped to obtain a level of polarization isolation that exceeds a second threshold over the specified bandwidth. In some embodiments, the first and second fence heights are dimensioned to obtain a level of mutual coupling that is less than a first threshold over a specified bandwidth, the third and fourth fence heights are dimensioned to obtain a level of return loss that is less than a second threshold over the specified bandwidth and the first and second inner slants are sloped to obtain a cross polarization ratio that exceeds a third threshold over the specified bandwidth. In some embodiments, the second inner slants of each of the two second parallel fences converge to a third point at the fourth fence height at the second center of the second fence. In some embodiments, the corner height is dimensioned to obtain a cross polarization ratio that is greater than a first threshold over a specified bandwidth and the two first outer slants are sloped to obtain a level of return loss that is less than a first threshold over the specified bandwidth. In some embodiments, the first and second fence heights are dimensioned to obtain a level of mutual coupling that is less than a first threshold over a specified bandwidth, and the third and fourth fence heights are dimensioned to obtain a level of return loss that is less than a second threshold over the specified bandwidth. In some embodiments, the first and second fence heights are dimensioned to obtain a level of mutual coupling that is less than a first threshold over a specified bandwidth and the third and fourth fence heights are dimensioned to obtain a level of polarization isolation that is greater than a second threshold over the specified bandwidth. In some embodiments, a first outer slant of the two first outer slants is configured to slope toward the first corner of the four corners to a fourth point that is a first distance away from the first corner. In some embodiments, a second outer slant of the two second outer slants is configured to slope toward the first corner of the four corners to a fifth point that is a second distance away from the first corner. In some embodiments, the first distance and the second distance, the gap, a corner height and a slope of the first outer slant and a slope of the second outer slant are dimensioned to obtain a cross polarization ratio above a first threshold and a level of mutual coupling that is less than a second threshold. In some embodiments, the first distance is greater than the second distance. In some embodiments, a first length of the two first parallel fences is different from a second length of the second two parallel fences.

According to another aspect, an ultra-wide band, UWB, Frasera antenna element is provided. The UWB Frasera antenna element includes a radiator and a fencing structure forming a perimeter around the radiator, the radiator having a first pair of two oppositely directed petals and a second pair of two oppositely directed petals, the first pair of oppositely directed petals being orthogonal to the second pair of oppositely directed petals, each petal extending from a center region of the radiator toward one of four corners of the fencing structure. The fencing structure has a first pair of two oppositely facing fences and a second pair of two oppositely facing fences, each oppositely facing fence being on a different side of the radiator, the two pairs of oppositely facing fences being configured to form the four corners of the fencing structure, each fence of a first pair of oppositely facing fences having a first center, a first fence height, first outer slants and first inner slants, each fence of a second pair of oppositely facing fences having a second center, a second fence height, second outer slants and second inner slants, a first outer slant extending from the first fence height to a corner height at a first corner, a second outer slant extending from the second fence height to the corner height at the first corner, a first inner slant extending from the first fence height to a third fence height at the first center, and a second inner slant extending from the second fence height to a fourth fence height at the second center.

According to this aspect, in some embodiments, the first two petals and the second two petals are bent to maintain a specified radiator spacing and the first and second fence heights are dimensioned to obtain a level of mutual coupling below a first threshold. In some embodiments, the first two petals and the second two petals are bent at a line so that a first part of the petal lies in a first plane that is perpendicular to a second plane having one of the first and second fences and a second part of the petal forms an angle with respect to the first part of the petal. In some embodiments, a length of a brim of each petal of the two pairs of oppositely directed petals is dimensioned to obtain a bandwidth of operation of the UWB antenna element that exceeds a specified bandwidth and the first and second fence heights are dimensioned to obtain a level of mutual coupling below a first threshold over the specified bandwidth. In some embodiments, the UWB antenna element further includes a connection assembly configured to provide electrical communication to each petal, wherein each petal includes a pair of tapers proximate to the connection assembly, each taper covering a portion of the connection assembly.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a top view of an 8×4 Frasera antenna array constructed according to principles set forth herein;

FIG. 2 is a perspective view of an 8×4 Frasera antenna array constructed according to principles set forth herein;

FIG. 3 is a perspective view of one example of an ultra-wide band (UWB) antenna element constructed according to principles set forth herein;

FIG. 4 is a perspective view of another example of an ultra-wide band (UWB) antenna element constructed according to principles set forth herein;

FIG. 5 is a top view of a corner formed by the junction of two fences constructed according to principles set forth herein;

FIG. 6 is a perspective view of a corner formed by the junction of two fence walls constructed according to principles set forth herein;

FIG. 7 is a top view of an antenna element showing a taper of a petal to cover a connection assembly;

FIG. 8 is a top view of a rectangular lattice of antenna elements disclosed herein;

FIG. 9 is a perspective view of a rectangular lattice of antenna elements disclosed herein;

FIG. 10 is a graph that shows the effect of corner gap size on the cross polarization ratio for a fixed gap height;

FIG. 11 is a graph of return loss versus frequency over a 45% bandwidth;

FIG. 12 is a graph of cross polarization discrimination versus frequency over a 45% bandwidth; and

FIG. 13 is a graph of polarization isolation versus frequency over a 45% bandwidth.

### DETAILED DESCRIPTION

Before describing in detail exemplary embodiments, it is noted that the embodiments reside primarily in combinations of apparatus components and processing steps related to an ultra-wide band (UWB) Frasera antenna radiator (UFAR) for Fifth Generation (5G) and Sixth Generation (6G) array antennas. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Embodiments disclosed herein may be employed in a 5G or 6G wireless device (WD) and/or a radio base station. Other radios that are not 5G or 6G compliant may also employ the embodiments disclosed herein. Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

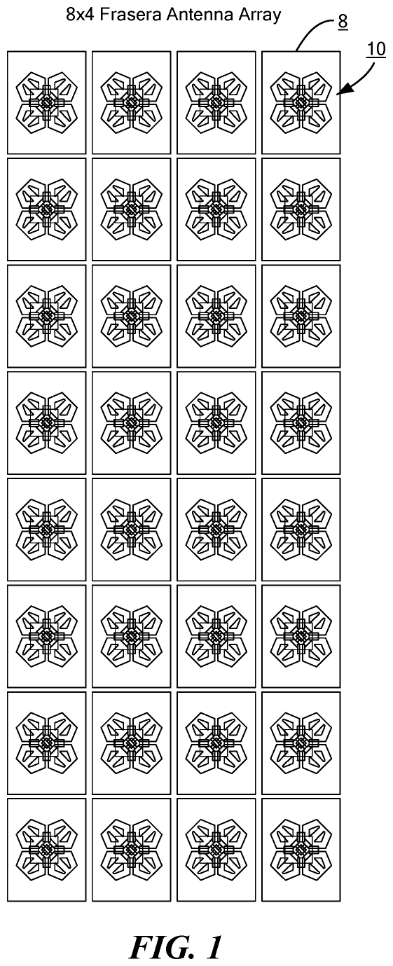

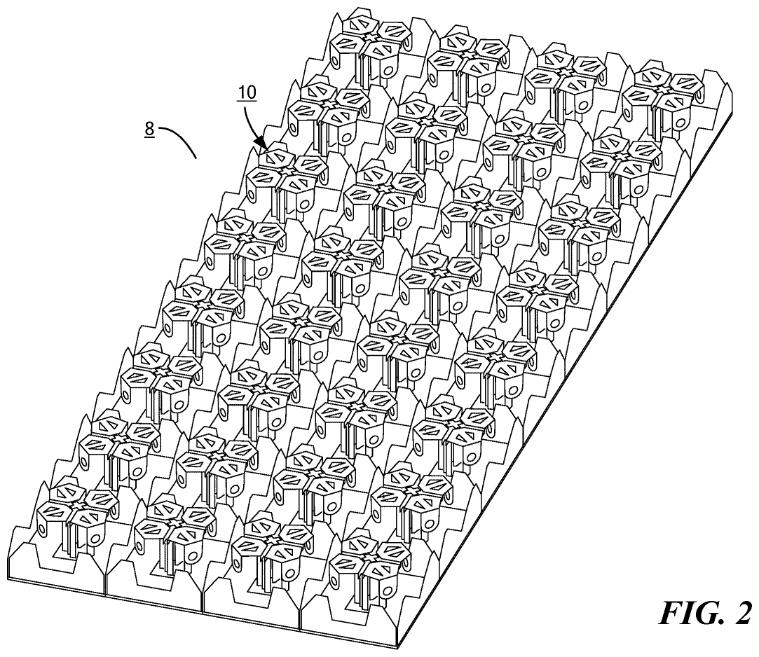

Some embodiments are directed to an ultra-wide band (UWB) Frasera antenna radiator (UFAR) for Fifth Generation (5G) and Sixth Generation (6G) array antennas. Referring to the drawing figures, in which like elements are referred to by like reference numerals, there is shown in FIG. 1 a top view of an 8×4 array 8 having 8 rows and 4 columns of dual-polarized ultra-wide band antenna elements 10 designed according to principles set forth herein. FIG. 2 is a perspective view of the array 8.

Challenges of designing an array of ultra-wide band antenna elements 10 to meet 5G and 6G requirements include at least one or more of the following:
A requirement of close column spacing of 59 millimeters (which is 0.34 wavelengths at a frequency of 1.71 GHz) results in strong mutual coupling between UFARs 10:
   At lower frequencies, there will be significant coupling between the antenna elements of the antenna array, which motivates a design of the radiator to be as small as possible, while still having good efficiency and radiation patterns at the lowest frequency;
In an array with the closely spaced columns, it is difficult to achieve good inverse polarization parallelity while meeting good polarization port isolation due to the interaction of the element fields with each other and with the radiation walls;
Performance requirements of radiators for 5G and 6G communications are to be met over a 45% bandwidth. Current designs have a 25% bandwidth for a column spacing of 75 mm which is 0.43 wavelengths at a frequency of 1.71 GHZ;
To reduce mutual coupling and improve radiation pattern symmetry, reduce port-to-port coupling and improve vertical steering performance requires a fence around each radiator of the antenna element 10, but a fence may tend to significantly reduce port-to-port isolation and increase return loss:
   coupling between antenna elements 10 may cause large excitation phase errors that cause beam steering errors and reduced uppers side lobe suppression (USLS);
Designing the fence to improve port-to-port isolation and reduce return loss may tend to worsen cross-polarization discrimination (XPD) and inverse polarization parallelity (IPP) (hereinafter the terms XPD and/or IPP shall be taken to mean both of these):
   IPP may tend to worsen around boresight where these parameters should be at their best values; and
   IPP is important for dual-polarization beamforming, network capacity and line of sight (LOS) throughput;
A vertical fence reduces mutual coupling between column-adjacent elements but may degrade polarization isolation:
   A horizontal fence may offset the impact on polarization isolation; but may have a negative impact on return loss; and
At the junction of orthogonal fences there is a gap to facilitate manufacture of the fencing structure. This gap can significantly degrade XPD and IPP, especially at boresight if not dimensioned correctly.

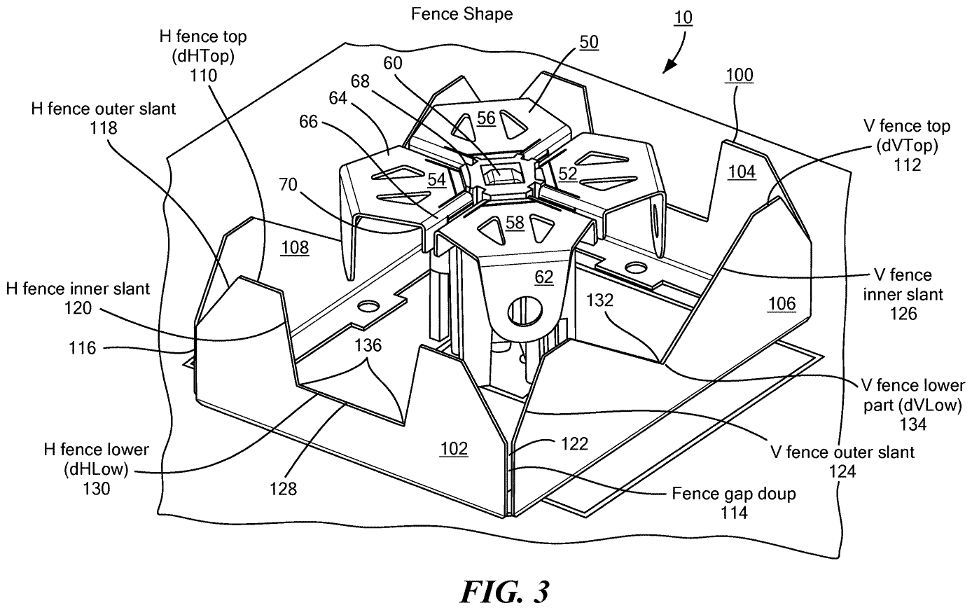

FIG. 3 is a diagram of an example of an UWB Fraser antenna element 10 having a radiator 50 and a fencing structure 100 and configured to provide radiation pattern symmetry and levels of cross polarization discrimination, polarization isolation and return loss over a specified bandwidth. The radiator 50 is configured to provide dual-polarization; a first polarization provided by antenna element petals 52 and 54 and the second polarization provided by petals 56 and 58. Each petal 52, 54, 56 and 58 is bent inward away from the plane of the petal toward a center 60 of the radiator 50 to form a tab 62. Therefore, the petal 52, 54, 56, 58 has a first part 64 that lies in a plane perpendicular to a plane of the fencing structure 100 and has a second part (the tab 62) that forms an angle with respect to the first part 64 of the petal 52, 54, 56, 58. Each petal 52, 54, 56 and 58 has a brim 66 that extends from a feed structure 68 to a first outer edge 70 of the petal 52, 54, 56 and 58.

The fencing structure 100 includes a first pair of parallel fences 102 and 104 associated with a horizontal beam scan direction. Thus, parallel fences 102 and 104 may be referred to as the horizontal fences. The fencing structure 100 also includes a second pair of parallel fences 106 and 108 associated with a vertical beam scan direction. Thus, the parallel fences 106 and 108 may be referred to as the vertical fences. The first pair of parallel fences 102, 104 are orthogonal to the second pair of parallel fences 106, 108. The first pair of parallel fences 102, 104 have a first fence height 110 and a first width 111 and the second pair of parallel fences 106, 108 have a second fence height 112 and a second width 113. The first fence height 110 and the second fence height 112 may be equal in some embodiments. In some embodiments, the first fence height 110 and the second fence height 112 are not equal. In some embodiments, the first width 111 of the first parallel fences 102, 104 and the second width 113 are equal. In some embodiments, the first width 111 of the first parallel fences 102, 104 and the second width 113 of the second pair of parallel fences 106, 108 are unequal.

In some embodiments, removal of material from the middle of the first pair of parallel fences 102, 104 improves return loss, XPD and IPP, but if the first inner slant (120) are too steep, polarization isolation is reduced. Therefore, a first width 131 between first endpoints 136 may be dimensioned to obtain a first return loss level, XPD and/or IPP that exceed respective first thresholds over the specified bandwidth, while maintaining polarization isolation below a second threshold over the specified bandwidth. In some embodiments, the first fence height 110 of the first pair of parallel fences 102, 104 is dimensioned to obtain a mutual coupling level that exceeds a first threshold over the specified bandwidth while maintaining an inner slant 120 that yields polarization isolation below a second threshold over the specified bandwidth.

In some embodiments, removal of material from the middle of the second pair of parallel fences 106, 108 improves return loss and polarization isolation, but if the first inner slant (126) XPD and IPP are too steep, polarization isolation is reduced. Therefore, a first width 135 between first endpoints 138 may be dimensioned to obtain a first return loss level and polarization isolation that exceed respective first thresholds over the specified bandwidth, while maintaining XPD and/or IPP below a second threshold over the specified bandwidth. In some embodiments, the second fence height 112 of the second pair of parallel fences 106, 108 is dimensioned to obtain a mutual coupling level that exceeds a first threshold over the specified bandwidth while maintaining an inner slant 126 that yields polarization isolation below a second threshold over the specified bandwidth.

In some embodiments the petals 52, 54, 56 and 58 are bent to maintain a specified radiator spacing and the first and second fence heights 110, 112 are dimensioned to obtain a level of mutual coupling below a first threshold over the specified frequency band. In some embodiments, the petals 52, 54, 56 and 58 are bent to form tabs 62 that are at an angle with respect to a first part 64 of the petals 52, 54, 56 and 58. In some embodiments, a length of the brim 66 of the petals 52, 54, 56, 58 is dimensioned to obtain a bandwidth of operation of the UWB antenna element 10 that exceeds the specified bandwidth and the first and second fence heights 110, 112 are dimensioned to obtain a mutual coupling level below a first threshold over the specified bandwidth. In some embodiments, the length of the brim 66 is dimensioned to obtain the bandwidth of operation that exceeds the specified bandwidth before the first and second fence heights are dimensioned to obtain the mutual coupling level over the specified bandwidth. In some embodiments, length of the brim 66 is dimensioned to obtain the bandwidth of operation that exceeds the specified bandwidth after the first and second fence heights 110, 112 are dimensioned to obtain the mutual coupling level over the specified bandwidth. In some embodiments, the dimensioning of the length of the brim 66 and the fence heights 110, 112 are dimensioned alternately and iteratively in steps until both the bandwidth of operation exceeds the specified bandwidth and the mutual coupling level is obtained over the specified bandwidth.

A junction of any two orthogonal fences of the first and second parallel fences 102, 104, 106, 108 forms a gap 114 at a corner 116. The first parallel fences 102, 104 have first outer slants 118 and first inner slants 120. The first outer slants 118 slope from the first fence height 110 to a corner height 122. The corner height 122 is less than the first fence height 110. The second parallel fences 106 and 108 have second outer slants 124 and second inner slants 126. The second outer slants 124 slope from the second fence height 112 to the corner height 122.

The first inner slants 120 slope from the first fence height 110 toward a center 128 of the parallel walls 102 and 104 at a third fence height 130. The second inner slants 126 slope from the second fence height 112 toward a center 132 at a fourth fence height 134. In some embodiments, the first inners slants 120 of the first two parallel fences 102, 104 terminate at first endpoints 136 separated by a first width at the third fence height 130 on either side of the center 128 of the fence 102, 104. In some embodiments, the second inner slants 126 of the second two parallel fences 106, 108 terminate at the fourth fence height 134 at the center 128 of the fence 106, 108.

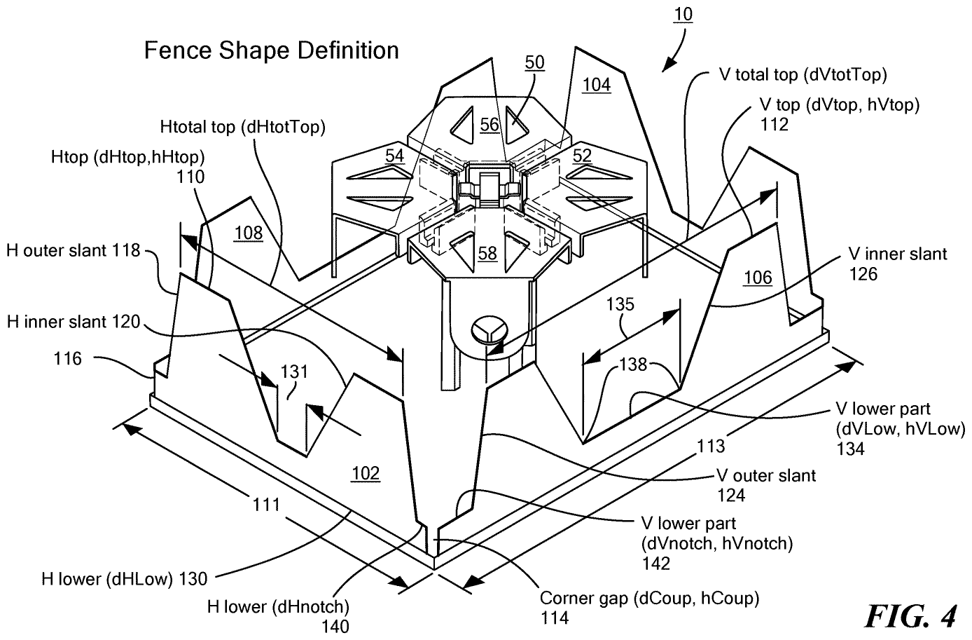

FIG. 4 is another example embodiment of an UWB antenna element 10 configured according to principles disclosed herein. In this embodiment, the inner slants 126 of the second two parallel fences 106, 108 terminate at second endpoints 138 separated by a second width at the fourth fence height 134 on either side of the center 132 of the second two parallel fences 106, 108. In some embodiments, the first width is equal to the second width. In some embodiments, the first width and the second width are unequal.

In some embodiments, the first and second fence heights 110, 112 are dimensioned to obtain a level of mutual coupling that is less than a first threshold over a specified bandwidth, and the first and second inner slants 120, 126 are sloped to obtain a level of polarization isolation that exceeds a second threshold over the specified bandwidth. In some embodiments, dimensioning the fence heights 110, 112 to obtain the level of mutual coupling over the specified bandwidth is performed prior to determining the slopes of the inner slants 120, 126 to obtain the level of polarization isolation over the specified bandwidth. In some embodiments, dimensioning the fence heights 110, 112 to obtain the level of mutual coupling over the specified bandwidth is performed after determining the slopes of the inner slants 120, 126 to obtain the level of polarization isolation over the specified bandwidth. In some embodiments, dimensioning the first and second fence heights 110, 112 and determining the slopes of the inner slants 120, 126 are performed alternately and iteratively in steps until both the mutual coupling level and the polarization isolation level over the specified bandwidth are obtained.

In some embodiments, the first and second fence heights 110, 112 are dimensioned to obtain a level of mutual coupling that is less than a first threshold over a specified bandwidth and the third and fourth fence heights 130, 134 are dimensioned to obtain a level of return loss that is less than a second threshold over the specified bandwidth.

Note that the difference between the first and second fence heights 110, 112 and the third and fourth fence heights 130, 134, as well as the distance between first and second endpoints 136, 138, respectively, determines the slope of the respective inner slants 120, 126. As noted the slopes of the inner slants 120, 126 may be sloped to obtain a polarization isolation level over the specified bandwidth and the first and second fence heights may be dimensioned to obtain a mutual coupling over the specified bandwidth. Therefore, the slope of the inner slants 120, 126 and the first and second fence heights 110, 112 may be dimensioned independently while the third and fourth fence heights are held constant. Conversely, the slope of the inner slants 120, 126 and the third and fourth fence heights 130, 134 may be dimensioned independently while the first and second fence heights 110, 112 are held constant.

In some embodiments, dimensioning the first and second fence heights 110, 112 to obtain the level of mutual coupling over the specified bandwidth is performed prior to dimensioning the third and fourth fence heights 130, 134 to obtain the level of return loss over the specified bandwidth. In some embodiments, dimensioning the first and second fence heights 110, 112 to obtain the level of mutual coupling over the specified bandwidth is performed after dimensioning the third and fourth fence heights 130, 134 to obtain the level of return loss over the specified bandwidth. In some embodiments, dimensioning the first and second fence heights 110, 112 and dimensioning the third and fourth fence heights 130, 134 are performed alternately and iteratively in steps until the mutual coupling level and the return loss level over the specified bandwidth are obtained.

In some embodiments, after the level of mutual coupling over the specified bandwidth is obtained and after the level of polarization isolation over the specified bandwidth is obtained, the first and second inner slants 120 and 126 are sloped to obtain a cross polarization ratio that exceeds a third threshold over the specified bandwidth.

In some embodiments, the corner height 122 is dimensioned to obtain a XPD level that is greater than a fourth threshold over the specified bandwidth and the first outer slants 118 are dimensioned to obtain a return loss level that is less than a first threshold over the specified bandwidth. In some embodiments, the corner height 122 is dimensioned to obtain the XPD level over the specified bandwidth prior to dimensioning the two outer slants 118 to obtain the return loss level over the specified bandwidth. In some embodiments, the corner height 122 is dimensioned to obtain the XPD level over the specified bandwidth after dimensioning the two outer slants 118 to obtain the return loss level over the specified bandwidth. In some embodiments, the corner height 122 and the first and second outer slants 118, 124 are dimensioned alternately and iteratively in steps until the XPD level and the return loss level over the specified bandwidth are obtained. In some embodiments, the corner height 122 and first outer slants 118 are dimensioned to obtain a first level of XPD and/or a second level of IPP in a boresight region.

In some embodiments, the first and second fence heights 110, 112 are dimensioned to obtain a mutual coupling level that is less than a first threshold over a specified bandwidth and the third and fourth fence heights 130, 134 are dimensioned to obtain a polarization isolation level that is greater than a second threshold over the specified bandwidth. In some embodiments, dimensioning the first and second fence heights 110, 112 to obtain the mutual coupling level over the specified bandwidth is performed prior to dimensioning the third and fourth fence heights 130, 134 to obtain the polarization isolation level over the specified bandwidth. In some embodiments, dimensioning the first and second fence heights 110, 112 to obtain the mutual coupling level over the specified bandwidth is performed after dimensioning the third and fourth fence heights 130, 134 to obtain the polarization isolation level over the specified bandwidth. In some embodiments, the first and second fence heights 110, 112 and the third and fourth fence heights 130, 134 are dimensioned alternately and iteratively in steps until the mutual coupling level and the polarization isolation level over the specified bandwidth are obtained.

In some embodiments, a first distance between first endpoints 136 of the inner slants 120 and a second distance between second endpoints 138 of the inner slants 126 are dimensioned to obtain a XPD above a first threshold and mutual coupling level that is less than a second threshold. In some embodiments, the first distance between first endpoints 136 is the same as the second distance between second endpoints 138. In some embodiments, the first distance between first endpoints 136 is different from the second distance between second endpoints 138.

In some embodiments, the second two parallel fences 106, 108 are provided to reduce mutual coupling between column-adjacent radiators 50 in the array 8 in order to obtain a degree of azimuth pattern symmetry and a port-to-port coupling between the columns that is lower than a threshold. The first fence height 110 may be dimensioned to significantly reduce mutual coupling at low frequencies, obtain an azimuth pattern symmetry and low port-to-port coupling. The first two parallel fences 102, 104 offset polarization isolation arising from the presence of the second two parallel fences 106, 108. In some embodiments, the fence 102 has the same geometry as the fence 106 and the fence 104 has the same geometry as the fence 108. In some embodiments, the first parallel fences 102 and 104 have a first geometry and the second parallel fences 106, 108 have a second geometry different from the first geometry.

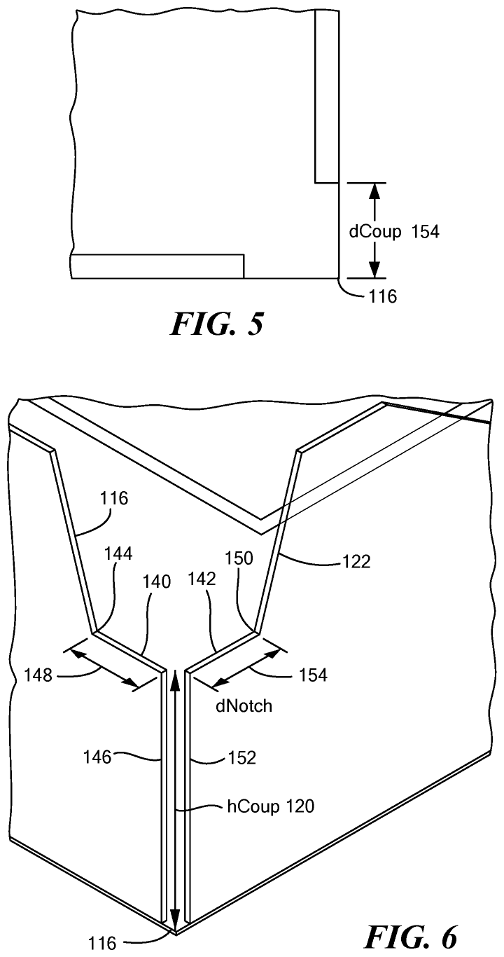

FIGS. 5 and 6 show a magnified view of a corner 116. In proximity to the corner 116, the first two parallel fences 102, 104 have a first lower notch 140 and the second two parallel fences 106, 108 have a second lower notch 142. The first lower notch 140 is at the corner height 122, and extends from a first point 144 to a first edge 146 of the first two parallel fences 102, 104. The first lower notch 140 therefore has first length 148 that extends from the first point 144 to the first edge 146 of the first two parallel fences 102, 104. The second lower notch 142 is at the corner height 122, and extends from a second point 150 to a second edge 152 of the second two parallel fences 106, 108. The second lower notch 142 therefore has a second length 154 that extends from the second point 150 to the second edge 152 of the second two parallel fences 106, 108. In some embodiments, the cross-polarization discrimination (XPD) and inverse polarization parallelity (IPP) may be improved by selectively dimensioning the first two parallel fences 102, 104 and/or the second two parallel fences 106, 108, as described above.

Dimensioning the fencing structure 100 affects a behavior of a ¾ wavelength resonance mode at a high end of the specified frequency band and may excite this mode to resonate. Further, a shape of the fencing structure dimensioned as explained above may significantly reduce an aperture size of the radiator 50 at a low end of the specified frequency band, thereby reducing a mutual coupling level and improve pattern symmetry.

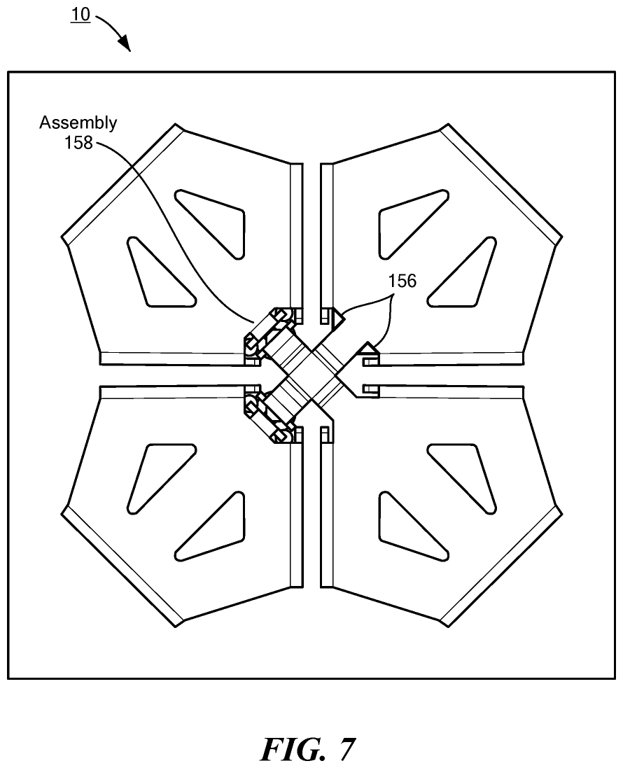

FIG. 7 is a top view of an antenna element 10 showing a taper 156 of a petal 52, 54, 56, 58 to cover the connection assembly 158 to improve the return loss over the specified bandwidth.

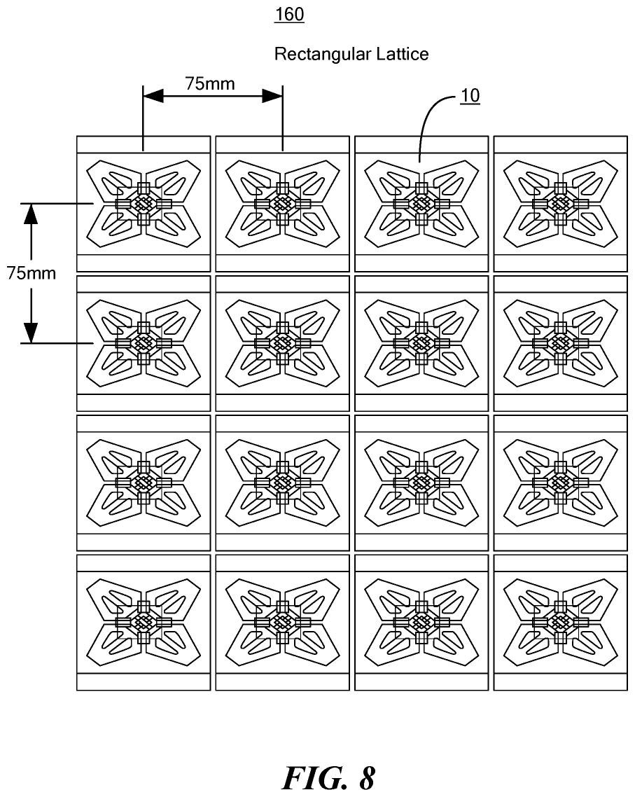

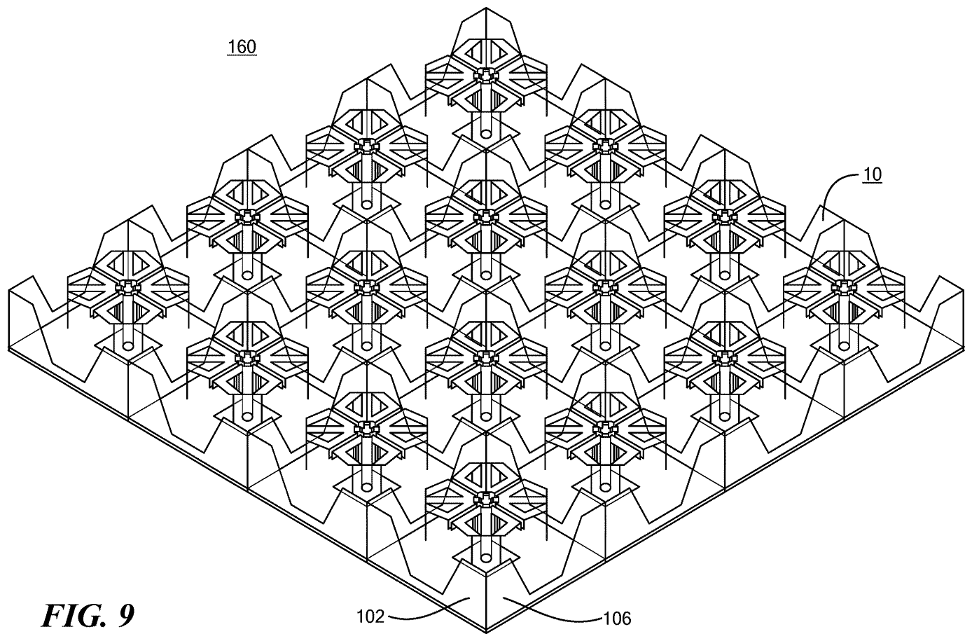

FIG. 8 is a rectangular array of antenna elements 10 and FIG. 9 is a perspective view of a rectangular array of antenna elements 10. In the example of FIG. 9, orthogonal fences 102 and 106 are similar in geometry (such as shown in FIG. 4), but other embodiments may be configured with fences that are dissimilar in geometry (such as shown in FIG. 3).

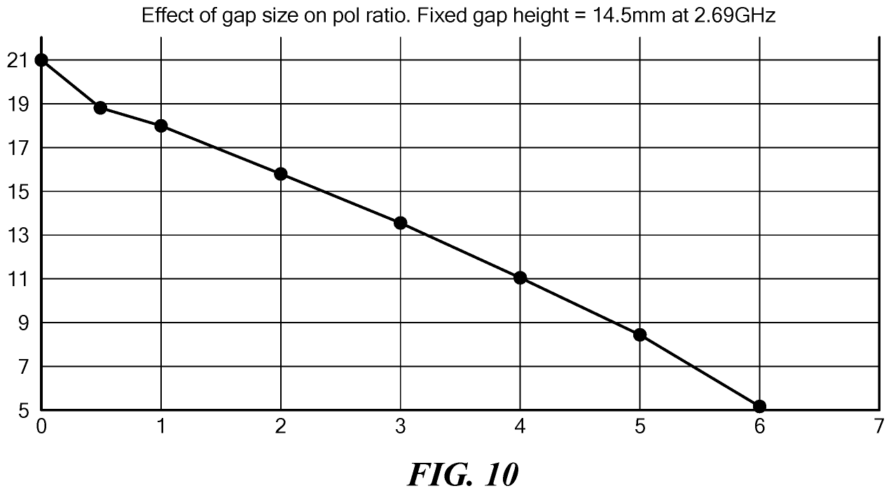

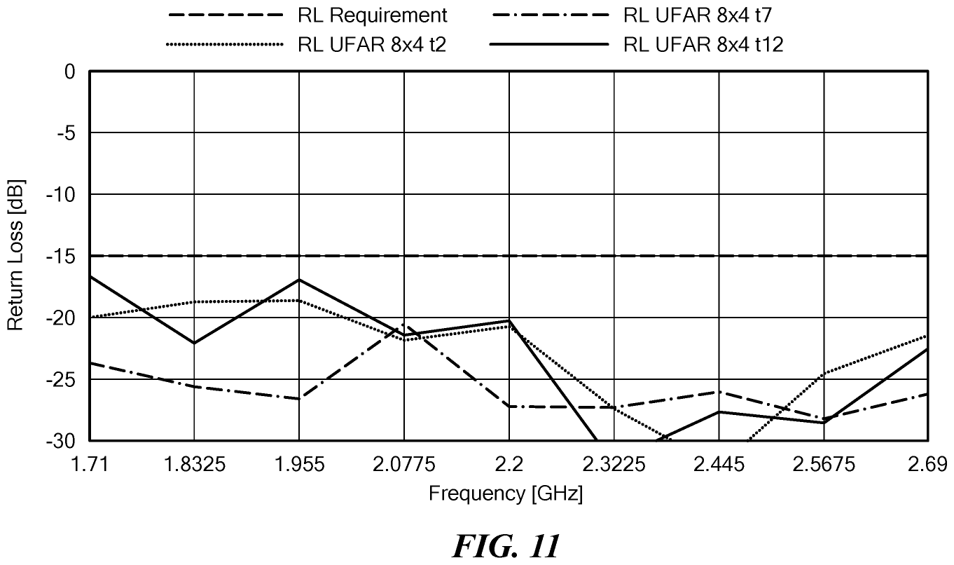

FIG. 10 shows the effect of the size of the gap 114 on a cross polarization ratio for a fixed corner height of 14.5 mm at 2.69 GHz. As the gap 114 becomes larger, the cross polarization ratio falls. In some embodiments, the gap 114, the corner height 122 and the first and second lengths 148, 154 are dimensioned to obtain a cross polarization ratio that exceeds a first threshold across an operating bandwidth of the radiator 50.

For the 8×4 array 8 using the Ultrawideband Frasera Radiator 50 and fence geometry 100 shown in FIGS. 1-3, optimal designs were obtained for a column spacing of 0.53 wavelength at 2.69 GHz and 0.33 wavelength at 1.71 GHz. For these designs, the size of the UWB Frasera antenna element 10 was reduced by 32% relative to a size of a known radiator while increasing the bandwidth from 25% to 45%. The wideband enhancement and size reduction is achieved with a combination of petal geometry (including size of the tab 62 and brim 66, fence geometry and fence height.

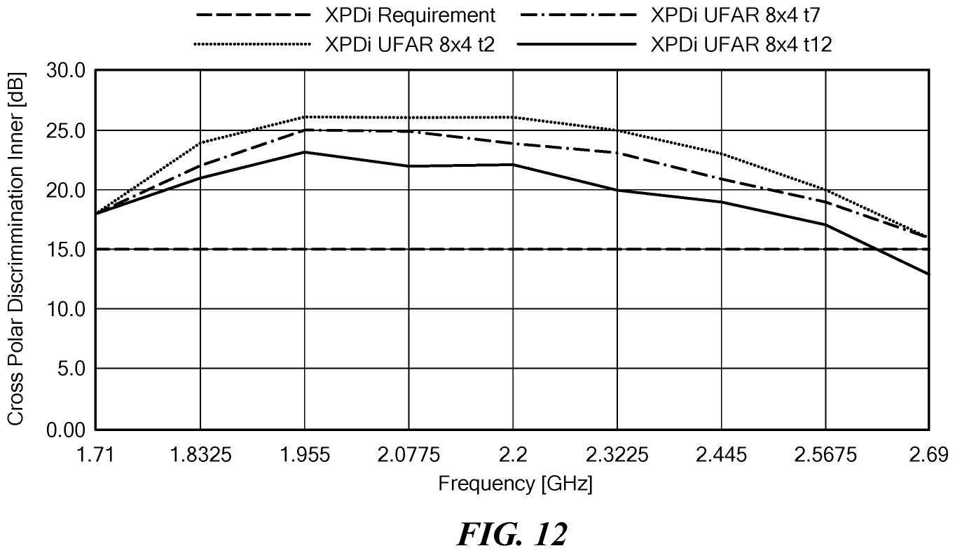

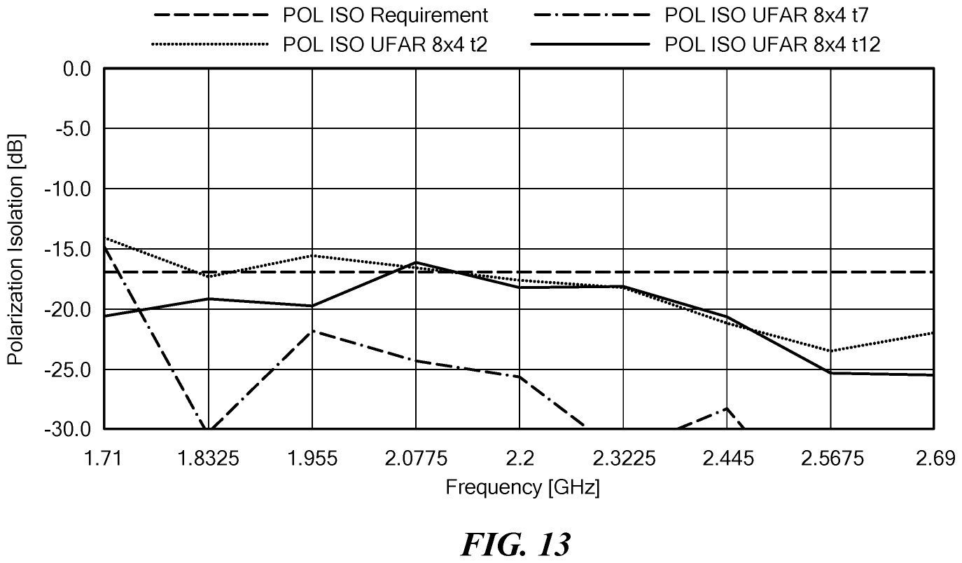

FIG. 11 is graph of example return loss versus frequency for a UWB antenna element 10 such as that in FIG. 3, for three different electrical down tilts (t2=2 degrees, t7=7 degrees and t12=12 degrees). FIG. 12 is a graph of cross polarization discrimination versus frequency for the UWB antenna 10 of FIG. 3, for the three different electrical down tilts (t2, t7 and t12) FIG. 13 is a graph of polarization isolation versus frequency for the UWB antenna 10 of FIG. 3 for the three different electrical down tilts (t2, t7 and t12)

Thus, specific fence geometry and radiator features disclosed herein are used to create the correct phase and amplitude response between antenna elements 10 in an array 8 or 162, for example, to optimize the coupling, polarization and other aspects as a function of frequency over the ultrawide bandwidth. The antenna elements 10 disclosed herein have improved return loss, improved polarization isolation between ports and improved radiation pattern performance, including cross polarization ratio and inverse polarization parallelity, as compared to known Frasera radiators.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An ultra-wide band (UWB) Frasera antenna element the UWB antenna element comprising:
a radiator configured to provide a first polarization and a second polarization; and
a fencing structure forming a perimeter around the radiator the fencing structure including two first parallel fences having a first fence height and two second parallel fences orthogonal to the two first parallel fences and having a second fence height, the two first parallel fences and the two second parallel fences forming a gap at each of four corners of the fencing structure, each of the two first parallel fences having two first outer slants each first outer slant being configured to slope toward a corner from the first fence height to a corner height and each of the two second parallel fences having two second outer slants, each second outer slant being configured to slope toward the corner of the four corners from the second fence height to the corner height the corner height being less than the first fence height and less than the second fence height, each of the two first parallel fences having a third fence height at a first center of the two first parallel fences, the third fence height being less than the first fence height the two second parallel fences having a fourth fence height at a second center of the two second parallel fences, the fourth fence height being less than the second fence height.

2. The UWB antenna element of claim 1, wherein a first fence of the two first parallel fences have two first inner slants sloping toward the first center of the first fence from the first fence height to the third fence height and a second fence of the two second parallel fences have two second inner slants sloping toward the second center from the second fence height to a fourth fence height of the second fence.

3. The UWB antenna element of claim 2, wherein each of the two first inner slants slope toward the first center of the first fence from opposite directions to the third fence height at first points separated by a first width.

4. The UWB antenna element of claim 3, wherein each of the two second inner slants slope toward the second center of the second fence from opposite directions to the fourth fence height at second points separated by a second width.

5. The UWB antenna element of claim 4, wherein the first width is greater than the second width.

6. The UWB antenna element of claim 2, wherein the first and second fence heights are dimensioned to obtain a level of mutual coupling that is less than a first threshold over a specified bandwidth, and the first and second inner slants are sloped to obtain a level of polarization isolation that exceeds a second threshold over the specified bandwidth.

7. The UWB antenna element of claim 2, wherein the first and second fence heights are dimensioned to obtain a level of mutual coupling that is less than a first threshold over a specified bandwidth, the third and fourth fence heights are dimensioned to obtain a level of return loss that is less than a second threshold over the specified bandwidth and the first and second inner slants are sloped to obtain a cross polarization ratio that exceeds a third threshold over the specified bandwidth.

8. The UWB antenna element of claim 2, wherein the second inner slants of each of the two second parallel fences converge to a third point at the fourth fence height at the second center of the second fence.

9. The UWB antenna element of claim 1, wherein the corner height is dimensioned to obtain a cross polarization ratio that is greater than a first threshold over a specified bandwidth and the two first outer slants are sloped to obtain a level of return loss that is less than a first threshold over the specified bandwidth.

10. The UWB antenna element of claim 1, wherein the first and second fence heights are dimensioned to obtain a level of mutual coupling that is less than a first threshold over a specified bandwidth, and the third and fourth fence heights are dimensioned to obtain a level of return loss that is less than a second threshold over the specified bandwidth.

11. The UWB antenna element of claim 1, wherein the first and second fence heights are dimensioned to obtain a level of mutual coupling that is less than a first threshold over a specified bandwidth and the third and fourth fence heights are dimensioned to obtain a level of polarization isolation that is greater than a second threshold over the specified bandwidth.

12. The UWB antenna element of claim 1, wherein a first outer slant of the two first outer slants is configured to slope toward the first corner of the four corners to a fourth point that is a first distance away from the first corner.

13. The UWB antenna element of claim 1, wherein a second outer slant of the two second outer slants is configured to slope toward the first corner of the four corners to a fifth point that is a second distance away from the first corner.

14. The UWB antenna element of claim 13, wherein the first distance and the second distance the gap, a corner height and a slope of the first outer slant and a slope of the second outer slant are dimensioned to obtain a cross polarization ratio above a first threshold and a level of mutual coupling that is less than a second threshold.

15. The UWB antenna element of claim 13, wherein the first distance is greater than the second distance.

16. The UWB antenna element of claim 1, wherein a first length of the two first parallel fences is different from a second length of the second two parallel fences.

17. An ultra-wide band, UWB, Frasera antenna element, the UWB Frasera antenna element comprising:
a radiator and a fencing structure forming a perimeter around the radiator
the radiator having a first pair of two oppositely directed petals and a second pair of two oppositely directed petals the first pair of oppositely directed petals being orthogonal to the second pair of oppositely directed petals each petal extending from a center region of the radiator toward one of four corners of the fencing structure; and
the fencing structure having a first pair of two oppositely facing fences and a second pair of two oppositely facing fences, each oppositely facing fence being on a different side of the radiator, the two pairs of oppositely facing fences being configured to form the four corners of the fencing structure each fence of a first pair of oppositely facing fences having a first center, a first fence height, first outer slants and first inner slants, each fence of a second pair of oppositely facing fences having a second center, a second fence height, second outer slants and second inner slants, a first outer slant extending from the first fence height to a corner height at a first corner, a second outer slant extending from the second fence height to the corner height at the first corner, a first inner slant extending from the first fence height to a third fence height at the first center, and a second inner slant extending from the second fence height to a fourth fence height at the second center.

18. The UWB Frasera antenna element of claim 17, wherein the first two petals and the second two petals are bent to maintain a specified radiator spacing and the first and second fence heights are dimensioned to obtain a level of mutual coupling below a first threshold.

19. The UWB Frasera antenna element of claim 17, wherein the first two petals and the second two petals are bent at a line so that a first part of the petal lies in a first plane that is perpendicular to a second plane having one of the first and second fences and a second part of the petal forms an angle with respect to the first part of the petal.

20. The UWB Frasera antenna element of claim 17, wherein a length of a brim of each petal of the two pairs of oppositely directed petals is dimensioned to obtain a bandwidth of operation of the UWB antenna element that exceeds a specified bandwidth and the first and second fence heights are dimensioned to obtain a level of mutual coupling below a first threshold over the specified bandwidth.

21. The UWB Frasera antenna element of claim 17, further comprising a connection assembly configured to provide electrical communication to each petal wherein each petal includes a pair of tapers proximate to the connection assembly, each taper covering a portion of the connection assembly.
